(19) United States
(12) Patent Application Publication
(10) Pub. No.: US 2011/0004486 A1
(43) Pub. Date: Jan. 6, 2011

(54) System and a Method for Purchasing Healthcare Products

(75) Inventor: George Smith, Johannesburg (ZA)

Correspondence Address: BAY AREA INTELLECTUAL PROPERTY GROUP, LLC, PO BOX 210459, SAN FRANCISCO, CA, 94121-0459, US

(73) Assignee: Laurus Consulting, Bedfordview (ZA)

(21) Appl. No.: 12/768,730

(22) Filed: Apr. 28, 2010

(30) Foreign Application Priority Data
Jul. 5, 2009 (ZA) 2009/03150

(51) Int. Cl. G06Q 50/00; G06Q 30/00; G06Q 20/00

(52) U.S. Cl. 705/2; 235/375

(57) ABSTRACT

A system and a method include a facility for storing and verifying transactions. A banking facility maintains deposit accounts. A healthcare provider supplies healthcare and or products. A purchasing platform enables a purchase of healthcare products. The purchasing platform is configured for communication with the facility and the banking facility. The purchasing platform is further configured for transmitting a value of a monetary instrument to the facility and the banking facility. The purchasing platform is further configured for receiving a voucher for the healthcare product. A patient presents the voucher to the healthcare provider and communicates information regarding the voucher and the healthcare provider to the facility and the banking facility. The information is verified. The healthcare provider is messaged with a confirmation of payment. The banking facility transfers a value of the voucher to the healthcare provider, and the healthcare provider supplies the patient with healthcare and or products.

### CROSS-REFERENCE TO RELATED APPLICATIONS

The present Utility patent application claims priority benefit of the South African provisional patent application entitled “Purchase of ‘Pay as you Go’ Healthcare Products via cellphone/mobile Networks Locally and Globally and Pay Healthcare Service Providers Fixed Amounts for Services as and when Requred” having application number 2009/03150 filed on Jul. 5, 2009 under 35 U.S.C. 119(a). The contents of this related provisional application are incorporated herein by reference for all purposes.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

The present invention relates generally to healthcare funding. More particularly, the invention relates to healthcare delivery and payment mechanisms.

### BACKGROUND OF THE INVENTION

Health care costs have been rising for several years. Expenditure in the United States on health care surpassed $2.3 trillion in 2008 (Kaiser Family Foundation). In general, there is agreement that health care cost will continue to rise, outpacing inflation for the foreseeable future.

Although people benefit from many of the investments in health care, the recent rapid cost growth is placing strains on the systems used to finance health care, including private employer-sponsored health insurance coverage and public insurance programs. With workers' wages growing at a much slower pace than health care costs, many face difficulty in affording out-of-pocket spending.

In the United States, according to a government survey in 2007 (Office of the Actuary, Centers for Medicare and Medicaid Services, National Health Expenditure Data for 2007, US Department of Health and Human Services) $286.6 billion was accounted for as out of pocket spending.

Alternative funding and payment solutions and mechanisms are consistently being sought to provide affordable health care to people within the United States which is outside of the current and traditional insurance funding healthcare mechanisms and solutions.

The demand for healthcare differs in important respects from the demand of other products as this demand is ‘derived demand’. The health economic literature explains that individuals will attempt to maximize their total utility, of which healthcare is one aspect. In other words, individuals do not consume healthcare primarily for the utility gained from the consumption as such, but rather form the perceived benefits in terms of improved healthcare and improved quality of life.

It is therefore important to understand what drives an individual's demand for healthcare, if it is not determined by the standard determinants of demand. There is a large amount of literature on the factors that determine the decision to obtain healthcare or not, and some of the factors generally listed include price, quality, income, social household and cultural characteristics, knowledge of healthcare available, and education.

It is therefore an objective of the present invention to provide an alternative funding mechanism and solution for healthcare delivery and an alternative payment mechanism and solution for healthcare providers using the latest technology and health care purchasing developments.

In view of the foregoing, there is a need for improved techniques for funding healthcare delivery.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a general structure of an exemplary system and methodology, in accordance with an embodiment of the present invention;

FIG. 2 is a flowchart illustrating an exemplary method for an individual to obtain and use a voucher, in accordance with an embodiment of the present invention;

FIG. 3 is a flowchart illustrating an exemplary method for administering a pay as you go health business, in accordance with an embodiment of the present invention;

FIG. 4 is a flowchart illustrating an exemplary method for healthcare providers participating in a pay as you go health business, in accordance with an embodiment of the present invention;

FIG. 5 is a block diagram illustrating an exemplary system for purchasing vouchers, in accordance with an embodiment of the present invention;

FIG. 6 is a flowchart illustrating an exemplary method for selling vouchers, in accordance with an embodiment of the present invention;

FIG. 7 is a flowchart illustrating an exemplary method for obtaining access to negotiated pricing, in accordance with an embodiment of the present invention;

FIG. 8 is a flowchart illustrating an exemplary method for paying insurance premiums, in accordance with an embodiment of the present invention; and

FIG. 9 illustrates a typical computer system that, when appropriately configured or designed, can serve as a computer system in which the invention may be embodied.

Unless otherwise indicated illustrations in the figures are not necessarily drawn to scale.

### SUMMARY OF THE INVENTION

To achieve the forgoing and other objects and in accordance with the purpose of the invention, a system and a method for purchasing healthcare products is presented.

In one embodiment a system means for storing and verifying transactions, means for maintaining deposit accounts, means for supplying healthcare and or products, and means for enabling a purchase of healthcare products. The enabling means being configured for communication with the storing and verifying means and the maintaining means, transmitting a value of a monetary instrument for payment of a healthcare product, and receiving a voucher for the healthcare product. Wherein a patient presents the voucher to the supplying means and communicates information regarding the voucher and the supplying means, the supplying means is messaged with a confirmation of payment, and the supplying means supplies the patient with healthcare and or products satisfying the healthcare product.

In another embodiment a system includes at least one facility for storing and verifying transactions. At least one banking facility maintains deposit accounts. At least one healthcare provider supplies healthcare and or products. A purchasing platform enables a purchase of healthcare products. The purchasing platform is configured for communication with the at least one facility and the at least one banking facility. The purchasing platform is further configured for transmitting a value of a monetary instrument for payment of a healthcare product to the at least one facility and the at least one banking facility. The purchasing platform is further configured for receiving from the at least one facility a voucher for the healthcare product. A patient, in communication with the at least one facility and the at least one banking facility, presents the voucher to the at least one healthcare provider and communicates information regarding the voucher and the at least one healthcare provider to the at least one facility and the at least one banking facility. The information is verified. The healthcare provider is messaged with a confirmation of payment. The at least one banking facility transfers a value of the voucher to the at least one healthcare provider, and the at least one healthcare provider supplies the patient with healthcare and or products satisfying the healthcare product. In another embodiment the purchasing platform is further configured to receive a list of healthcare providers supplying healthcare and or products satisfying the healthcare product. In yet another embodiment the purchasing platform is further configured to present a list of available healthcare products for purchase. In still another embodiment the purchasing platform is further configured to request and receive a list of negotiated prices for healthcare procedures. In another embodiment the purchasing platform further includes a mobile communication device. In yet another embodiment the voucher is loaded into the mobile communication device. In still another embodiment the purchasing platform further includes a point-of sale system. In another embodiment the point-of sale system includes a point-of sale terminal for interfacing with a customer, and an interface configured for communicating with the customer's mobile communication device enabling loading of the voucher on the customer's mobile communication device. In yet another embodiment the point-of sale system further includes a card reader/writer for enabling loading of the voucher on a card. In still another embodiment the point-of sale system further includes a printer for printing lists. In another embodiment the monetary instrument is cash.

In another embodiment a method includes providing a facility for storing and verifying transactions. A banking facility is provided for maintaining deposit accounts. A healthcare provider is provided for supplying healthcare and or products. A purchasing platform is provided for enabling a purchase of healthcare products. Included are steps for establishing a communication between the purchasing platform, the facility and the banking facility for initiating a purchase of a healthcare product. Included are steps for transmitting a value of a monetary instrument for payment of a healthcare product from the purchasing platform to the facility and the banking facility for storing the transmission, for establishing a deposit account, and for transforming the value of the monetary instrument into a voucher for the healthcare product. Included are steps for receiving at the purchasing platform the voucher. Included are steps for conveying the voucher to a patient. Included are steps for receiving from the patient a communication that the voucher is being presented to the healthcare provider. Included are steps for verifying the communication. Included are steps for messaging the healthcare provider with a confirmation of the verifying. Included are steps for transferring a value of the voucher from the deposit account to the healthcare provider. Also included are steps for supplying the patient, from the healthcare provider, with healthcare and or products satisfying the healthcare product, thereby transforming the voucher into the healthcare and or products. Another embodiment further includes steps for receiving at the purchasing platform a list of healthcare providers supplying healthcare and or products satisfying the healthcare product, and conveying the list to the patient. Yet another embodiment further includes steps for presenting a list of available healthcare products for purchase at the purchasing platform. Still another embodiment further includes steps for receiving at the purchasing platform a list of negotiated prices for healthcare procedures.

In another embodiment a method includes the steps of providing a facility for storing and verifying transactions. A banking facility is provided for maintaining deposit accounts. A healthcare provider is provided for supplying healthcare and or products. A purchasing platform is provided for enabling a purchase of healthcare products. A communication is established between the purchasing platform, the facility and the banking facility for initiating a purchase of a healthcare product. A value of a monetary instrument for payment of a healthcare product is transmitted from the purchasing platform to the facility and the banking facility for storing the transmission, for establishing a deposit account, and for transforming the value of the monetary instrument into a voucher for the healthcare product. The purchasing platform receives the voucher. The voucher is conveyed to a patient. A communication that the voucher is being presented to the healthcare provider is received from the patient. The communication is verified. The healthcare provider is messaged with a confirmation of the verifying. A value of the voucher is transferred from the deposit account to the healthcare provider. The healthcare provider supplies the patient with healthcare and or products satisfying the healthcare product, thereby transforming the voucher into the healthcare and or products. Another embodiment further includes the steps of receiving at the purchasing platform a list of healthcare providers supplying healthcare and or products satisfying the healthcare product, and conveying the list to the patient. Yet another embodiment further includes the steps of presenting a list of available healthcare products for purchase at the purchasing platform. Still another embodiment further includes the steps of receiving at the purchasing platform from the facility a list of negotiated prices for healthcare procedures. In another embodiment the purchasing platform further includes a mobile communication device. In yet another embodiment the voucher is loaded into the mobile communication device. In still another embodiment the purchasing platform further includes a point-of sale system. In another embodiment the point-of sale system includes a point-of sale terminal for interfacing with a customer, and an interface configured for communicating with the customer's mobile communication device enabling loading of the voucher on the customer's mobile communication device. In yet another embodiment the point-of sale system further includes a card reader/writer for enabling loading of the voucher on a card. In still another embodiment the point-of sale system further includes a printer for printing lists. In another embodiment the monetary instrument is cash.

Other features, advantages, and objects of the present invention will become more apparent and be more readily understood from the following detailed description, which should be read in conjunction with the accompanying drawings.

### DETAILED DESCRIPTION OF THE PREFERRED EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Preferred embodiments of the present invention provide a method and a system for an alternative financing methodology for the procurement of cost-effective healthcare services. In some preferred embodiments the process and products allow for an alternative funding and payment process with integration of various aspects including, but not limited to, clinical, pricing or purchasing, funding and payment, within a mobile platform. Some preferred embodiments provide for a mobile banking platform for the delivery of healthcare services by contracted healthcare providers. In some preferred embodiment the consumer can fund their out-of-pocket healthcare needs at their own pace, without the onerous insurance type healthcare funding mechanisms. In some preferred embodiments the consumer can use this type of funding mechanism to provide healthcare to dependants or others at their own discretion and affordability. In some preferred embodiments the consumer can use this type of funding mechanism to provide healthcare to dependants or others at their own discretion and affordability. In preferred embodiments healthcare providers can receive payment without having to do the labor intensive claiming process usually associated with healthcare claims from insurance companies and government departments. Some preferred embodiments of the present invention are based on “cash-less” mechanism so the consumer is never in an embarrassing situation as not having required cash on hand to pay for services. In some embodiments, a “Cash-less” payment means could entail the mechanism whereby the healthcare provider would receive payment for services (e.g., at an agreed price) via electronic payment or transfer directly into their nominated banking account. The cost of the transaction (e.g., a banking fee) could be included in “agreed price” therefore savings accured in either handling traditional cash payment or card payment. This is because the entire transaction is done through the parties mobile phones and the pricing for set services is pre-determined within the product. Preferred embodiments of the present invention uses various pricing methodologies whereby the pricing is fixed for service within the product for example, but not limited to, General Practice (GP) Consultation+minor procedures+medicines, as opposed to the traditional fee for service pricing mechanisms in use. Providers are incentivized to practice cost effective care. The risk of healthcare, being utilization and price, is clearly distinguished and the provider is taking the risk of price. The purchasing methodologies are based on the contractual relationship with the providers.

In various preferred embodiments of the present invention, pay as you go health or pre-paid health methodologies addresses mainly out of pocket spend, such as, but not limited to, consultations and medication, and healthcare products being purchased on as needed basis. In some preferred embodiments methodologies are based on mobile phone networks banking platform and revenue collection methods based purchasing of doctors consultations, medication and related medical products and services. In some embodiments a mobile banking platform is used as a payment mechanism to medical practitioners such as, but not limited to, doctors, general practitioners, pharmacists, dentists, optometrists, etc. In some preferred embodiments of the present invention, pay as you go health or pre-paid health products may be purchased by anyone via a cell phone. The system would enable access to a healthcare menu via a mobile network. In a non-limiting example, keying in a specified key code would take a client to a healthcare drop down menu offering various product options. Products would then be purchased via the cell phone and a ‘voucher’ then stored on the cell phone and on an electronic database. The cell phone user then has a healthcare ‘voucher/package’ purchased which could be used and redeemed at any medical doctor on the pay as you go health network or pre-paid network. A Short Message Service (SMS) or text message could be sent to the client or patient indicating the closest doctors in the area in which he is currently located or wishes to be treated. In some preferred embodiments of the present invention, medical providers are settled instantly upon seeing a client through the client inputting a ‘code’ which could be for example, but not limited to, a doctors medical practice number, and transmitting from their cell phone. This would result in the medical practitioner being paid or redeeming the voucher instantaneously. In alternate embodiments, the practitioner may be paid within a specified period of time. This process of pay as you go health or pre-paid health results in a significant saving to doctors as they do not need to attend to debt collections and are paid immediately. In preferred embodiments of the present invention pay as you go health or pre-paid health products and services are acquired and negotiated by experts in the healthcare procurement field. Typically clients do not know how to purchase healthcare, whereas with preferred embodiments of the present invention, they would have access to, or own signed, formal contracts and/or service level agreements signed by medical practitioners committing to services to be rendered and products to be supplied. Some embodiments of the present invention can be used by both the medically uninsured and medically insured clients. In some preferred embodiments healthcare products and services are internationally recognized and accepted irrespective of the country where purchased. Preferred embodiments of the present invention ensure that the funds used to purchase the healthcare product can only be used for healthcare. This ensures that companies, employers and individuals providing pay as you go health or pre-paid health vouchers to staff, friends or family are virtually guaranteed that the funds allocated are being used for what is intended, namely healthcare. Giving someone money for healthcare does not necessarily mean that the funds will be used for healthcare, however, the voucher of the present invention can only be used for healthcare services and products. In some embodiments of the present invention can be used in both first world and third world economies by, but not limited to, governments for National Health Insurance, non-governmental organizations (NGO's) wishing to provide alternative affordable healthcare products and services to communities or individuals in the form of telemedicine or rural healthcare initiatives or similar subsidized or ‘free’ healthcare solutions, employer groups for medically uninsured staff and medically insured staff, migrant workers, and general population requiring private sector healthcare at affordable pre-negotiated rates.

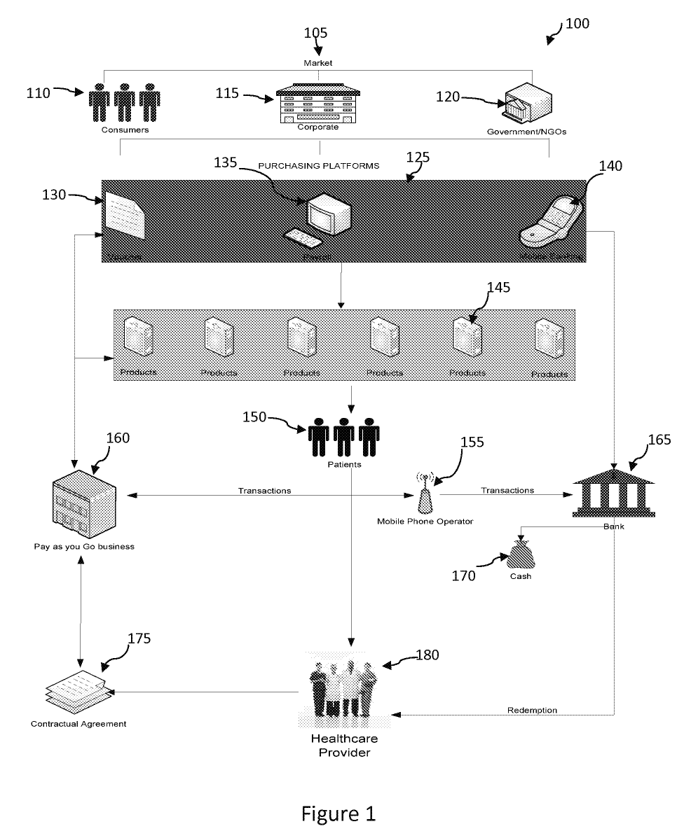

FIG. 1 illustrates a general structure of an exemplary system and methodology, in accordance with an embodiment of the present invention. The system and methodology 100 includes a market 105 of potential purchasers of pay as you go health or pre-paid health products. Market 105 is made up of, but not limited to, individual consumers 110, corporate 115, government/NGO's 120. Individual consumers 110 include, but not limited to, uninsured individuals, insured individuals, and of any nationality. Corporate 115 includes, but is not limited to, companies of any size including health care corporations. Government/NGOs may include, but not limited to national or state department, and any non-government organization wishing to provide citizens subsidized or unsubsidized health care. Purchasing platforms 125 provide means for market 105 to obtain or distribute pay as you go health or pre-paid health products 145. Purchasing platforms 125 include, but not limited to, vouchers 130, vouchers obtained from employer payroll 135 and vouchers obtained using a mobile banking device 140. Other platforms contempalted, without limitation, include vouchers obtain through loyalty programmes, vouchers obtained through government or NGO sponsored programs. Patients 150 receive vouchers for one or more products 145 that may have been obtained from one of the purchasing platforms 125. Patients 150 may also receive vouchers from, but not limited to, friends, relatives or concerned individuals, etc. who have obtained vouchers on their behalf. In some preferred embodiments vouchers are typically retained on a mobile communication device such as, a cell phone, smart phone, communications pad, or other portable devices with storage systems. Patients 150 in turn visit healthcare provider 180 that has contractual agreement 175 with pay as you go health business 160 to perform health services at agreed upon rates. Patients 150 display to healthcare provider 180 the voucher for the services required. Healthcare provider then supplies patients 150 with their healthcare provider identification number. In some preferred embodiments patients 150 use their communication device to contact pay as you go health business 160 and/or bank 165. Patients 150 then transmit a code for the voucher and the healthcare provider's identification number. In alternative embodiments, the healthcare provider 180 may assist patients 150 with the transmitting of the information. After voucher has been verified, healthcare provider 180 receives, but not limited to, a SMS, text message, email, or other instant message confirming that the services have been paid for and deposit has been or will be made to their account. Healthcare provider 180 then performs the services paid for.

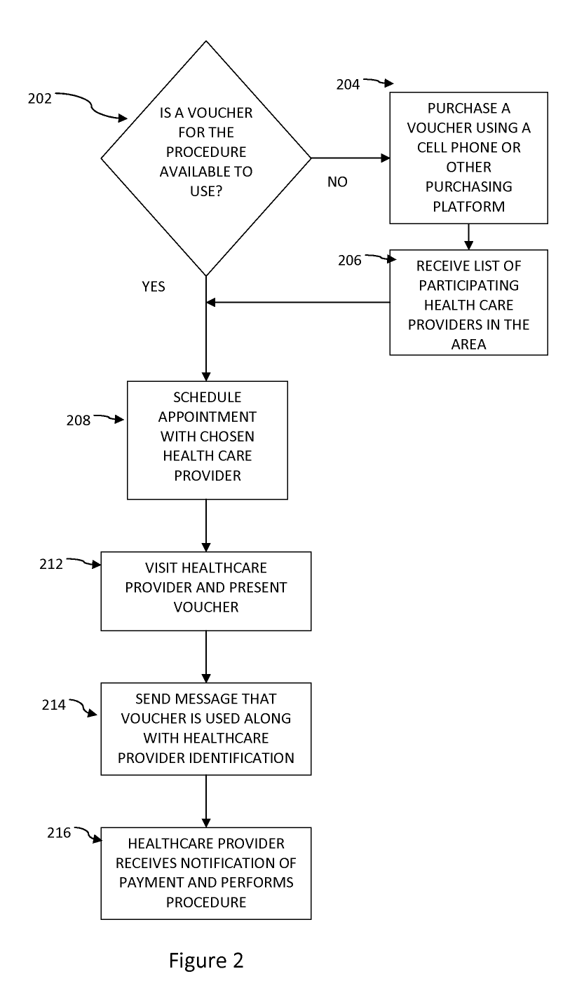

FIG. 2 is a flowchart illustrating an exemplary method for an individual to obtain and use a voucher, in accordance with an embodiment of the present invention. In step 202 an individual determines if they are in possession of a voucher that covers the procedure that is desired. The individual may have previous obtained a voucher from one of the purchasing platforms 125 shown in FIG. 1, or may have obtained vouchers from, but not limited to, friends, relatives or concerned individuals, etc. who have obtained vouchers on their behalf. If the individual does not have a voucher, they obtain the voucher in step 204. In step 206, when they receive the voucher, they also receive a list of participating healthcare providers in their area that will perform the procedure. In step 208, the individual chooses a healthcare provider from the list and schedules an appointment. In step 212 the individual presents the voucher to the healthcare provider. Healthcare provider then makes available to the individual the healthcare provider's identification number. In other embodiments, the healthcare provider's identification number may have been sent with the list in step 206. The individual then uses their communication device, preferably, but not limited to, a cell phone, smart phone, communication pad or other mobile communication device to transmit a voucher code and the healthcare provider's identification to a pay as you go health business, bank, voucher provider or any other facility responsible for handling vouchers in step 214. After voucher has been verified, in step 216, healthcare provider receives a message such as, but not limited to, a SMS, text message, email, or other instant message confirming that the services have been paid for and deposit has been or will be made to their account. Healthcare provider then performs the procedure that has been paid for.

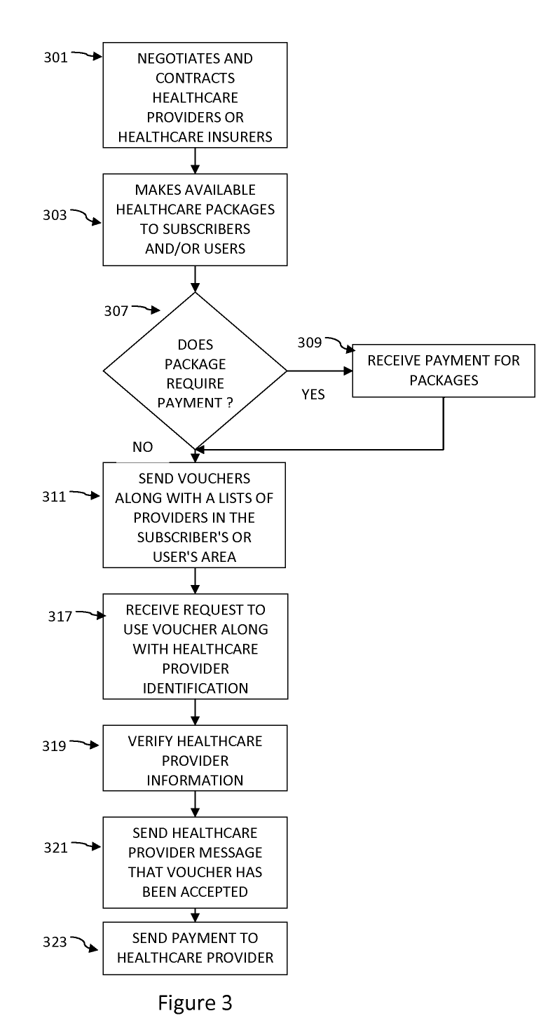

FIG. 3 is a flowchart illustrating an exemplary method for administering a pay as you go health business, in accordance with an embodiment of the present invention. In step 301 contracts with healthcare providers are negotiated. The contracts are generally acquired by experts in the healthcare procurement field or from healthcare insurers. In step 303 various healthcare packages are made available to subscribers and/or users of the pay as you go health system. In some embodiments payment for packages may not be required such as, but not limited to, packages which are part of a health insurance plan, a benefit from an employer, etc. In step 307, when a subscriber and/or user requests a package and a payment is required, the process goes to step 309 for receiving payment, otherwise the process go to step 311. In step 309, payment for the package received. Payment may be received by various means such as, but not limited to, cash payment at a point of sale (POS) terminal, banking transfer, credit card, debit card, wire transfer, etc. Typically, payments are placed in a deposit account at a bank or other financial institution. In step 311, one or more paid vouchers are sent to the requester along with a list of healthcare provider in the requester area. In some embodiments the requester can select the area for the list. When a subscriber and/or user wishes to use a voucher, in step 317, a unique code for the voucher and a healthcare provider identification is received. In step 319, the voucher and healthcare provider information is verified. After the information has been verified, in step 321 the healthcare provider is messaged that the voucher has been accepted and that payment has been or will be sent. In step 323 the payment is sent to the healthcare provider.

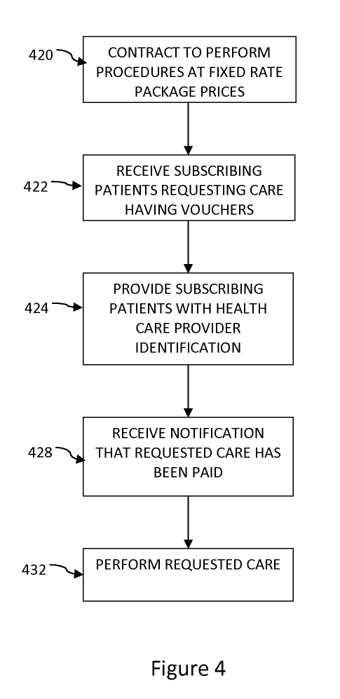

FIG. 4 is a flowchart illustrating an exemplary method for healthcare providers participating in a pay as you go health business, in accordance with an embodiment of the present invention. In step 420 healthcare providers contract to perform procedures at fixed rate package prices. In step 422 the healthcare providers receive patients requesting care and presenting vouchers. In step 424 the patients are provided with the healthcare provider's identification number for transmittal. In alternate embodiments, the healthcare provider may assist the patients in transmitting the required information. In step 428 the healthcare provider receives notification of payment. In step 432 the healthcare provider performs the procedure.

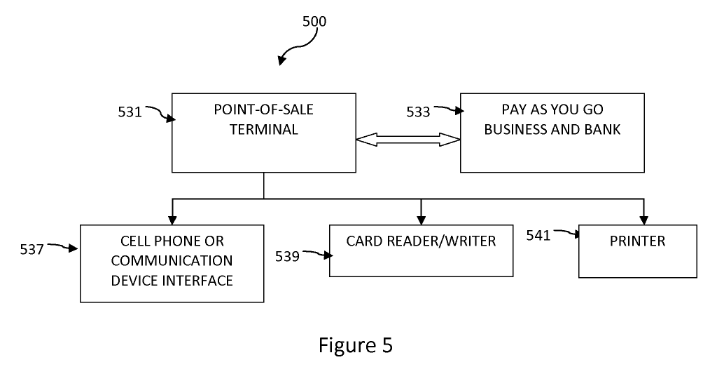

FIG. 5 is a block diagram illustrating an exemplary system for purchasing vouchers, in accordance with an embodiment of the present invention. System 500 illustrates a simplistic point-of sale system that a vendor may utilize to sell pay as you go healthcare products. Those skilled in the art, in light of the teaching of the present invention will readily configure a suitable cell phone interface depending upon the needs of the particular application. System 500 may be positioned in various easy access locations such as, but not limited to, convenience stores, shopping malls, drug stores, airports, train stations, bus stations, etc. System 500 may be configured for attended or unattended sale of vouchers. System 500 includes point-of-sale terminal 531 for accepting cash, credit cards, debit cards or any acceptable monetary instrument. A customer, after selecting a pay as you go healthcare product, presents their selection at point-of-sale terminal 531. Point-of-sale terminal 531 is in communication with pay as you go business 160 and bank 165. Upon payment, a voucher is created having a unique identifier, funds are typically transferred to a deposit account and the transaction is recorded. Point-of-sale terminal 531 is connected to interface 537 for communicating with the purchaser's cell phone or mobile communication device. The purchased voucher is loaded, via interface 537, into the cell phone or mobile communication device. Should the customer not have a compatible device or the voucher is being purchased for another individual, the voucher may be loaded into an electronically readable card using card reader/writer 539. When a voucher is purchased, the pay as you go health system generates a list of participating healthcare providers in the area or near a location specified by the customer. This list can be printed out by printer 541. The list may also contain instructions for using the voucher and obtaining assistance. The electronically readable card may also have printed instructions for using the voucher and obtaining assistance.

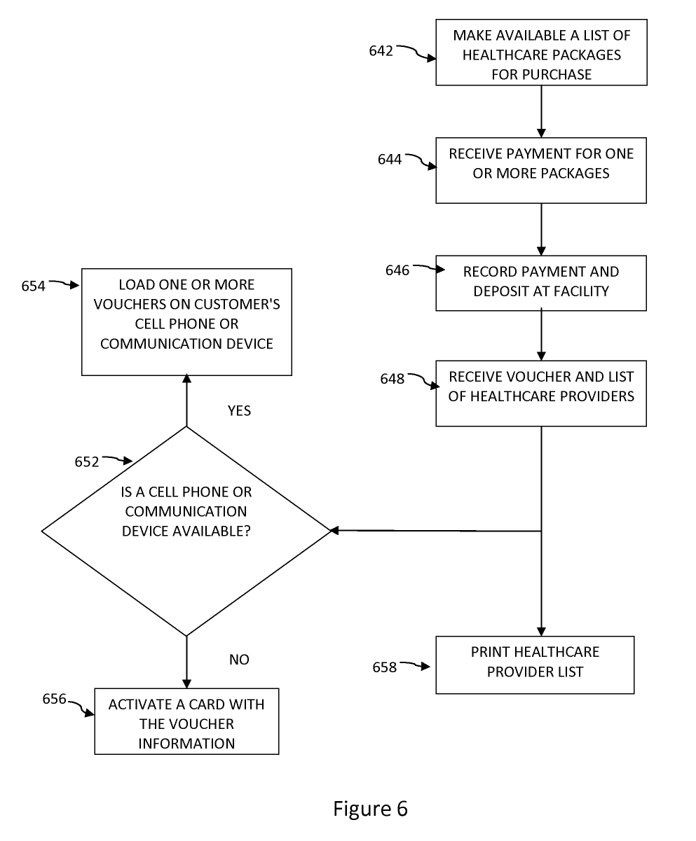

FIG. 6 is a flowchart illustrating an exemplary method for selling vouchers, in accordance with an embodiment of the present invention. In step 642 a list of available healthcare packages for sale is made available to a customer. In step 644 payment is received for one or more packages. In step 646 the transaction information is sent to the pay as you go healthcare system. In step 648 a paid voucher and list of healthcare providers is received. Step 652 determines if a cell phone or communication device is available for loading the voucher. If a cell phone or communication device is available the voucher is loaded in step 654. If a cell phone or communication device is not available an electronically readable card is loaded with the voucher in step 656. In step 658 the list of healthcare providers is printed.

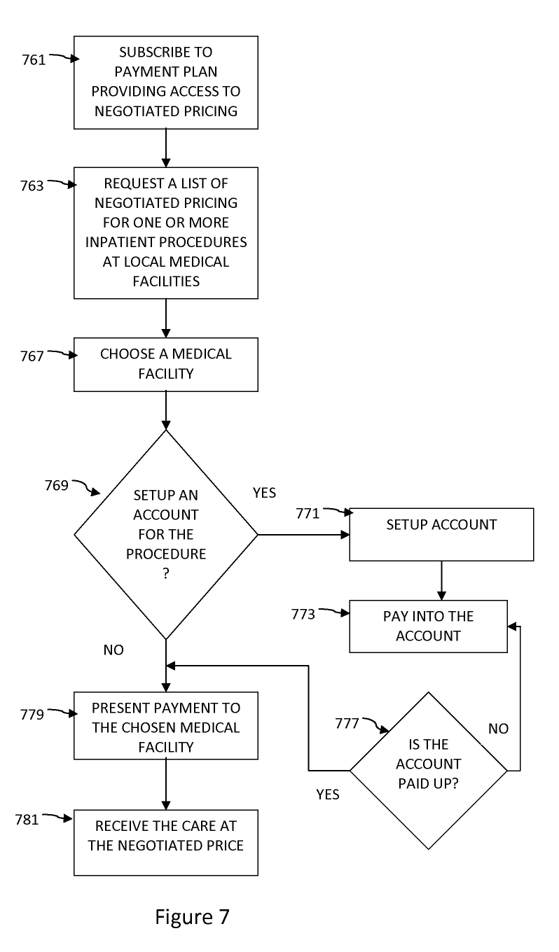

FIG. 7 is a flowchart illustrating an exemplary method for obtaining access to negotiated pricing, in accordance with an embodiment of the present invention. In step 761 a customer subscribes to periodic payment plan to gain access to negotiated pricing for major medical procedures. In order to mitigate abuse of the system, the customer may be required to make a specified amount of payments before gaining access to the pricing. After gaining access, the customer may request a list of negotiated pricing for one or more inpatient procedures at local medical facilities in step 763. In step 767 the customer may choose a medical facility to have a procedure performed. In step 769 the customer can chose to have a payment account setup for the cost of the procedure. If the customer wishes to setup an account then the customer proceeds to step 771 to setup and step 773 to make a payment into the account. The customer need not pay the full amount all at once, but may make multiple payments over a period of time. When the account is paid up, in step 777, the customer may then produce a paid voucher to the chosen medical facility in step 779 and receive the care at the negotiated price in step 781. If the customer does not wish to setup an account, then the customer may pay the medical facility directly or make arrangements to pay in step 779 to receive the care at the negotiated price in step 781.

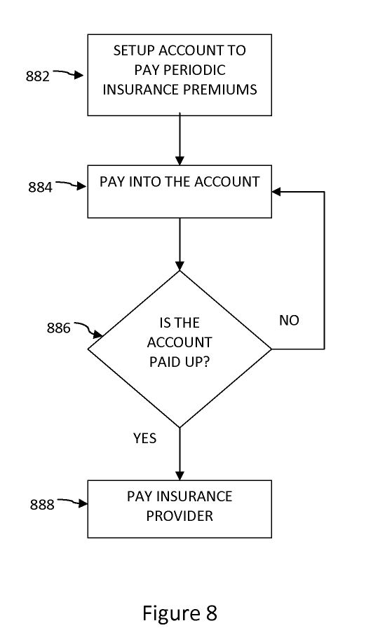

FIG. 8 is a flowchart illustrating an exemplary method for paying insurance premiums, in accordance with an embodiment of the present invention. In step 882 an account is setup for the cost of the periodic insurance premium. This could be accomplished using one of the purchasing platforms 125. In a non-limiting example, a customer may use the system shown in FIG. 5. In this case, the customer would provide the necessary information regarding the insurance provider and the premiums due. In step 884, the customer pays an amount into the account that he/she feels comfortable with. This payment could be in cash for those that may not have banking or credit accounts. The customer could then use any POS terminal to pay into the account. In step 886, when sufficient funds have been deposited in the account to pay a premium, the insurance provider is paid in step 888. The insurance provider paid directly via electronic funds transfer or the customer may receive a voucher to present to an agent of the insurance provider.

Those skilled in the art will readily recognize, in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

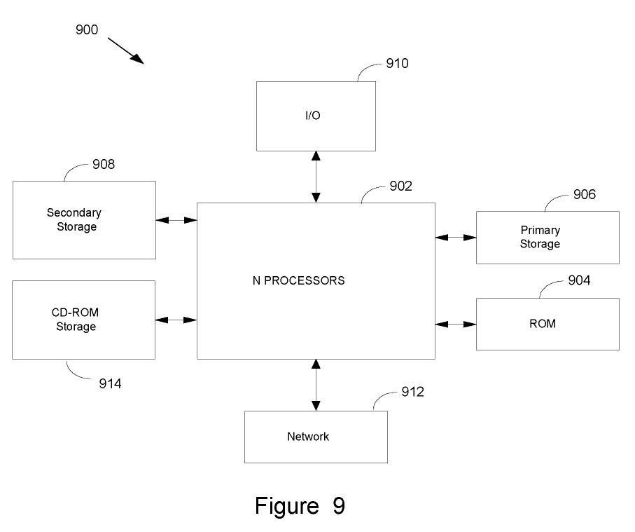

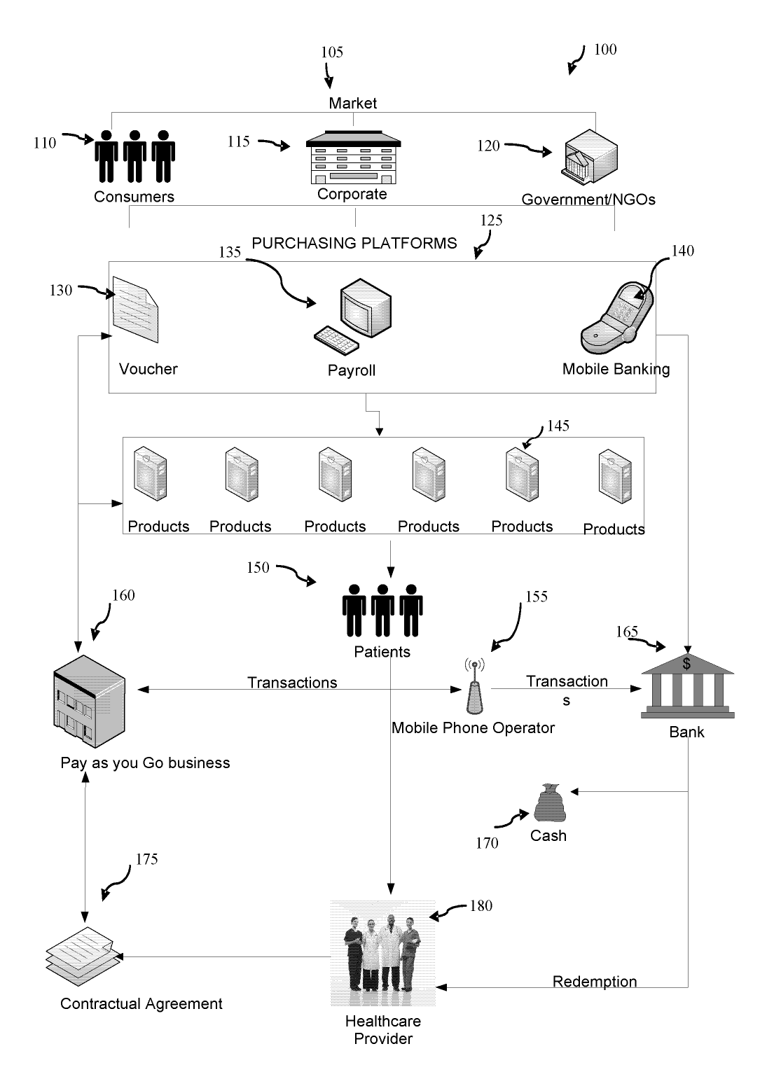

FIG. 9 illustrates a typical computer system that, when appropriately configured or designed, can serve as a computer system in which the invention may be embodied. The computer system 900 includes any number of processors 902 (also referred to as central processing units, or CPUs) that are coupled to storage devices including primary storage 906 (typically a random access memory, or RAM), primary storage 904 (typically a read only memory, or ROM). CPU 902 may be of various types including microcontrollers (e.g., with embedded RAM/ROM) and microprocessors such as programmable devices (e.g., RISC or SISC based, or CPLDs and FPGAs) and unprogrammable devices such as gate array ASICs or general purpose microprocessors. As is well known in the art, primary storage 904 acts to transfer data and instructions uni-directionally to the CPU and primary storage 906 is used typically to transfer data and instructions in a bi-directional manner. Both of these primary storage devices may include any suitable computer-readable media such as those described above. A mass storage device 908 may also be coupled bi-directionally to CPU 902 and provides additional data storage capacity and may include any of the computer-readable media described above. Mass storage device 908 may be used to store programs, data and the like and is typically a secondary storage medium such as a hard disk. It will be appreciated that the information retained within the mass storage device 908, may, in appropriate cases, be incorporated in standard fashion as part of primary storage 906 as virtual memory. A specific mass storage device such as a CD-ROM 914 may also pass data uni-directionally to the CPU.

CPU 902 may also be coupled to an interface 910 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 902 optionally may be coupled to an external device such as a database or a computer or telecommunications or internet network using an external connection as shown generally at 912, which may be implemented as a hardwired or wireless communications link using suitable conventional technologies. With such a connection, it is contemplated that the CPU might receive information from the network, or might output information to the network in the course of performing the method steps described in the teachings of the present invention.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing novel means for and/or steps described that the applications designer will selectively decide, depending upon the practical considerations of the particular implementation, to carry out and/or locate within the jurisdiction of the USA. For any claims construction of the following claims that are construed under 35 USC §112(6) it is intended that the corresponding means for and/or steps for carrying out the claimed function also include those embodiments, and equivalents, as contemplated above that implement at least some novel aspects and objects of the present invention in the jurisdiction of the USA. For example, purchasing and using may be performed and/or located outside of the jurisdiction of the USA while the remaining method steps and/or system components of the forgoing embodiments are typically required to be located/performed in the US for practical considerations.

Having fully described at least one embodiment of the present invention, other equivalent or alternative methods of purchasing vouchers according to the present invention will be apparent to those skilled in the art. The invention has been described above by way of illustration, and the specific embodiments disclosed are not intended to limit the invention to the particular forms disclosed. For example, the particular implementation of the point-of-sale system may vary depending upon the particular type of terminals, locations where the system may be used and if the system is attended or unattended. The purchasing platforms and vouchers described in the foregoing were directed to delivery of healthcare products however, similar techniques are may be applicable to delivery and purchase of other packaged products. Non-healthcare implementations of the present invention are contemplated as within the scope of the present invention. The invention is thus to cover all modifications, equivalents, and alternatives falling within the spirit and scope of the following claims.

Claim elements and steps herein have been numbered and/or lettered solely as an aid in readability and understanding. As such, the numbering and lettering in itself is not intended to and should not be taken to indicate the ordering of elements and/or steps in the claims.

What is claimed is:

1. A system comprising:
means for storing and verifying transactions;
means for maintaining deposit accounts;
means for supplying healthcare and or products; and
means for enabling a purchase of healthcare products, said enabling means configured for communication with said storing and verifying means and said maintaining means, transmitting a value of a monetary instrument for payment of a healthcare product, and receiving a voucher for said healthcare product, wherein a patient presents said voucher to said supplying means and communicates information regarding said voucher and said supplying means, said supplying means is messaged with a confirmation of payment, and said supplying means supplies the patient with healthcare and or products satisfying said healthcare product.

2. A system comprising:
at least one facility for storing and verifying transactions;
at least one banking facility for maintaining deposit accounts;
at least one healthcare provider for supplying healthcare and or products; and
a purchasing platform for enabling a purchase of healthcare products, said purchasing platform configured for communication with said at least one facility and said at least one banking facility, said purchasing platform further configured for transmitting a value of a monetary instrument for payment of a healthcare product to said at least one facility and said at least one banking facility, said purchasing platform further configured for receiving from said at least one facility a voucher for said healthcare product, wherein a patient, in communication with said at least one facility and said at least one banking facility, presents said voucher to said at least one healthcare provider and communicates information regarding said voucher and said at least one healthcare provider to said at least one facility and said at least one banking facility, said information is verified, said healthcare provider is messaged with a confirmation of payment, said at least one banking facility transfers a value of said voucher to said at least one healthcare provider, and said at least one healthcare provider supplies the patient with healthcare and or products satisfying said healthcare product.

3. The system as recited in claim 2, wherein said purchasing platform is further configured to receive a list of healthcare providers supplying healthcare and or products satisfying said healthcare product.

4. The system as recited in claim 2, wherein said purchasing platform is further configured to present a list of available healthcare products for purchase.

5. The system as recited in claim 2, wherein said purchasing platform is further configured to request and receive a list of negotiated prices for healthcare procedures.

6. The system as recited in claim 2, wherein said purchasing platform further comprises a mobile communication device.

7. The system as recited in claim 6, wherein said voucher is loaded into said mobile communication device.

8. The system as recited in claim 2, wherein said purchasing platform further comprises a point-of sale system.

9. The system as recited in claim 8, wherein said point-of sale system comprises:
a point-of sale terminal for interfacing with a customer; and
an interface configured for communicating with the customer's mobile communication device enabling loading of said voucher on the customer's mobile communication device.

10. The system as recited in claim 9, wherein said point-of sale system further comprises a card reader/writer for enabling loading of said voucher on a card.

11. The system as recited in claim 9, wherein said point-of sale system further comprises a printer for printing lists.

12. The system as recited in claim 2, wherein said monetary instrument is cash.

13. A method comprising:
creating a facility for storing and verifying transactions;
creating a banking facility for maintaining deposit accounts;
making available a healthcare provider for supplying healthcare services and/or products;
configuring a purchasing platform for enabling a purchase of said healthcare products;
steps for establishing a communication between said purchasing platform, said facility and said banking facility for initiating a purchase of a healthcare product;
steps for transmitting a value of a monetary instrument for payment of a healthcare product from said purchasing platform to said facility and said banking facility for storing said transmission, for establishing a deposit account, and for transforming said value of said monetary instrument into a voucher for said healthcare product;
steps for receiving at said purchasing platform said voucher;
steps for conveying said voucher to a patient;
steps for receiving from the patient a communication that said voucher is being presented to said healthcare provider;
steps for verifying said communication;
steps for messaging said healthcare provider with a confirmation of said verifying;
steps for transferring a value of said voucher from said deposit account to said healthcare provider; and
steps for supplying the patient, from said healthcare provider, with healthcare and or products satisfying said healthcare product, thereby transforming said voucher into said healthcare and or products.

14. The method as recited in claim 13, further comprising steps for receiving at said purchasing platform a list of healthcare providers supplying healthcare and or products satisfying said healthcare product, and conveying said list to the patient.

15. The method as recited in claim 13, further comprising steps for presenting a list of available healthcare products for purchase at said purchasing platform.

16. The method as recited in claim 13, further comprising steps for receiving at said purchasing platform a list of negotiated prices for healthcare procedures.

17. A method comprising the steps of:
providing a facility for storing and verifying transactions;
providing a banking facility for maintaining deposit accounts;
providing a healthcare provider for supplying healthcare and or products;
providing a purchasing platform for enabling a purchase of healthcare products;
establishing a communication between said purchasing platform, said facility and said banking facility for initiating a purchase of a healthcare product;
transmitting a value of a monetary instrument for payment of a healthcare product from said purchasing platform to said facility and said banking facility for storing said transmission, for establishing a deposit account, and for transforming said value of said monetary instrument into a voucher for said healthcare product;
receiving at said purchasing platform said voucher;
conveying said voucher to a patient;
receiving from the patient a communication that said voucher is being presented to said healthcare provider;
verifying said communication;
messaging said healthcare provider with a confirmation of said verifying;
transferring a value of said voucher from said deposit account to said healthcare provider; and
supplying the patient, from said healthcare provider, with healthcare and or products satisfying said healthcare product, thereby transforming said voucher into said healthcare and or products.

18. The method as recited in claim 17, further comprising the steps of receiving at said purchasing platform a list of healthcare providers supplying healthcare and or products satisfying said healthcare product, and conveying said list to the patient.

19. The method as recited in claim 17, further comprising the steps of presenting a list of available healthcare products for purchase at said purchasing platform.

20. The method as recited in claim 17, further comprising the steps of receiving at said purchasing platform from said facility a list of negotiated prices for healthcare procedures.

21. The method as recited in claim 17, wherein said purchasing platform further comprises a mobile communication device.

22. The method as recited in claim 21, wherein said voucher is loaded into said mobile communication device.

23. The method as recited in claim 17, wherein said purchasing platform further comprises a point-of sale system.

24. The method as recited in claim 23, wherein said point-of sale system comprises:
a point-of sale terminal for interfacing with a customer; and
an interface configured for communicating with the customer's mobile communication device enabling loading of said voucher on the customer's mobile communication device.

25. The method as recited in claim 24, wherein said point-of sale system further comprises a card reader/writer for enabling loading of said voucher on a card.

26. The method as recited in claim 24, wherein said point-of sale system further comprises a printer for printing lists.

27. The method as recited in claim 17, wherein said monetary instrument is cash.
